(19) United States
(12) Patent Application Publication
(10) Pub. No.: US 2024/0425381 A1
(43) Pub. Date: Dec. 26, 2024

(54) PROCESSING HARD ROCK LITHIUM MINERALS OR OTHER MATERIALS TO PRODUCE LITHIUM MATERIALS AND BYPRODUCTS CONVERTED FROM A SODIUM SULFATE INTERMEDIATE PRODUCT

(71) Applicant: Frontier Lithium Inc., Val Caron (CA)

(72) Inventor: Naizhen Cao, Val Caron (CA)

(73) Assignee: Frontier Lithium Inc., Val Caron (CA)

(21) Appl. No.: 18/686,507

(22) PCT Filed: Aug. 29, 2022
(86) PCT No.: PCT/IB22/58067

§ 371 Date: Feb. 26, 2024

Related U.S. Application Data
(60) Provisional application No. 63/237,900, filed on Aug. 27, 2021.

(51) Int. Cl. C01D 15/08; C01D 1/04; C01D 1/20; C01D 5/00; C01D 9/00; C01D 15/02; C01F 11/46; H01M 10/54

(52) U.S. Cl. CPC C01D 15/08; C01D 1/04; C01D 1/20; C01D 5/00; C01D 9/00; C01D 15/02; C01F 11/46; H01M 10/54

(57) ABSTRACT

Methods are provided for processing a lithium-containing material (e.g., a mineral like spodumene) whereby a lithium sulfate solution derived from the material is reacted with a primary reagent (e.g., Na₂CO₃ or NaOH) to produce a mixed solution of primary lithium product (e.g., Li₂CO₃ or LiOH) and Na₂SO₄. In addition to primary lithium product, a separated Na₂SO₄ solution is produced and converted to a byproduct (e.g., CaSO₄, NaNO₃, NaOH, H₂SO₄) by reaction with a salt chemical (e.g., Ca(NO₃)₂) or alkali chemical (e.g., Ca(OH)₂), or by electrolysis or electrodialysis. Byproducts are re-used to reduce reagent inputs. Residual lithium in an output solution is reacted with a secondary reagent (e.g., CO₂ from flue gas, or H₃PO₄) to produce secondary lithium products (e.g., Li₂CO₃ or Li₃PO₄), which may be re-used to reduce reagent inputs and increase lithium recovery.

### CROSS-REFERENCE

This application claims priority to U.S. Provisional Patent Application No. 63/237,900 filed on Aug. 27, 2021 (“PROCESSING HARD ROCK LITHIUM MINERALS OR OTHER MATERIALS TO PRODUCE LITHIUM MATERIALS AND BYPRODUCTS CONVERTED FROM A SODIUM SULFATE INTERMEDIATE PRODUCT”), which is entirely incorporated herein by reference.

### FIELD

The present disclosure relates to methods for processing hard rock lithium minerals and other lithium containing materials to either produce lithium carbonate (Li₂CO₃) or lithium hydroxide monohydrate (LiOH—H₂O), and a byproduct converted from a Na₂SO₄ intermediate product.

### BACKGROUND

Electrically-powered vehicles and other machines are increasing in popularity due to market demand, regulatory requirements, and political desire to reduce fossil fuel consumption and greenhouse gas emissions. This transition requires economical production of large volumes of lithium materials for batteries.

Lithium carbonate (Li₂CO₃ or LC) and lithium hydroxide monohydrate (LiOH—H₂O, or LHM) are the two most important basic lithium materials for lithium battery production and for many other lithium related industries.

Lithium is extracted from two main lithium sources: liquid brine containing lithium; and hard rock deposits containing lithium such as spodumene. Spodumene is a pyroxene mineral consisting of lithium aluminum inosilicate (LiAl(SiCO₃)₂). The naturally-occurring low-temperature form α-spodumene is in the monoclinic system, and the high-temperature β-spodumene crystallizes in the tetragonal system. α-spodumene converts to β-spodumene at temperatures above 900° C.

To produce Li₂CO₃ and LiOH—H₂O from hard rock, the sulfuric acid process is the most reliable technology, and is therefore the mostly used process in current lithium industry.

FIG. 1 shows a prior art method for processing α-spodumene concentrate to produce Li₂CO₃. Solid α-spodumene concentrate is converted to β-spodumene by kiln calcination. Then β-spodumene is mixed with H₂SO₄ and subjected to acid roasting. Then the acid-roasted material is mixed with water in leaching tanks where lithium and other metal impurities are leached into solution. Limestone powder (CaCO₃), lime (CaO) or hydrated lime (Ca(OH)₂), NaOH, Na₂CO₃ or any other reagent which can precipitate the impurities may be added to the solution to change the pH and remove the impurities. By solid/liquid (S/L) separation, leaching residue and impurity residue are separated, and a pregnant leach solution (PLS) is obtained. If necessary, an ion exchange (IX) circuit is further used to remove Ca and Mg impurities. By this purification, clean PLS solution comprising Li₂SO₄ is obtained. The purified Li₂SO₄ PLS solution is reacted with Na₂CO₃ to precipitate Li₂CO₃. The precipitated Li₂CO₃ is separated and dried as Li₂CO₃ product. If battery-grade product is desired, the wet Li₂CO₃ cake obtained is re-dissolved and further purified by the CO₂ method known in the prior art. The wet Li₂CO₃ obtained after filtration is dried to produce a final battery-grade Li₂CO₃ product. Usually, before final packing, there are magnetic impurity removal steps in some parts of the process and a micronizing step to reduce the size of Li₂CO₃ particles to a desired size, as well as, some evaporation steps to increase concentration of main compositions. The mother liquor from Li₂CO₃ solid/liquid separation goes to a Na₂SO₄ crystallization circuit to get rid of Na₂SO₄ solid from the process. The mother liquor and condensed water after Na₂SO₄ crystallization can be recycled to the process for re-use.

FIG. 2 shows a prior art method for processing α-spodumene concentrate to produce lithium hydroxide monohydrate LiOH—H₂O. The method is similar to the method of FIG. 1 for producing Li₂CO₃, with differences as follows. The purified Li₂SO₄ PLS is reacted with NaOH to produce mixed LiOH and Na₂SO₄ solution. By freezing treatment, a typical method used in current lithium industry and known in the prior art, Na₂SO₄ is separated from the solution in the form of Glauber's salt (Na₂SO₄-10H₂O). The Na₂SO₄-removed LiOH PLS solution is sent to crystallizer to produce wet LiOH cake. The wet LiOH cake is dried to produce a final LiOH—H₂O product. If battery-grade product is desired, the produced wet LiOH cake is re-dissolved and subjected to secondary or tertiary crystallization, as required. The mother liquor and condensed water of LiOH crystallization is recycled to the process for re-use. In another stream, the Glauber's salt separated from the PLS is re-dissolved and the resulting Na₂SO₄ solution is sent to an evaporator for Na₂SO₄ crystallization. The mother liquor and condensed water of Na₂SO₄ crystallization are recycled to the process for re-use.

In general, the processes of FIGS. 1 and 2 produce up to more than 2 tons of Na₂SO₄ for 1 ton of Li₂CO₃ or LiOH—H₂O. This is problematic for many reasons. First, the Na₂SO₄ byproduct needs a special production plant for its crystallization, which requires a high capital investment. For example, up to $15 million USD of capital investment is required for a typical Na₂SO₄ crystallizer plant for a 20 KT Lithium Carbonate Equivalent (LCE) chemical plant. This significantly increases capital expenditure, and significantly lowers production profit. Second, evaporating water from the very large volume of Na₂SO₄ solution consumes a large amount of energy. Third, NaOH or Na₂CO₃ is consumed in the chemical conversion reaction from Li₂SO₄ solution to Na₂SO₄ byproduct. NaOH and Na₂CO₃ are higher value chemicals than Na₂SO₄, and therefore this impairs the economics of the process. Last, but not the least, the marketability of the Na₂SO₄ byproduct is limited. Use of Na₂SO₄ for the production of detergent powder accounts for more than 80% of the total market for Na₂SO₄, and this market is found mainly in Asian countries. This means that in countries outside of Asia, especially in North America and Europe, it will be economically prohibitive to produce lithium materials from hard rock with the conventional process as illustrated in FIGS. 1 and 2, despite the production of Na₂SO₄ as a byproduct and its transport to economically viable markets. Moreover, mining industries and many other industries also produce large volumes of Na₂SO₄, making for a supply-rich market of Na₂SO₄.

The processes of FIGS. 1 and 2 also produce CO₂ emissions, as a result of combustion of fossil fuels to produce heat for the calcination and acid-roasting steps, as well as steam generation for the process. These CO₂ emissions may act as greenhouse gases that contribute to climate change.

Nonetheless, the conventional processes of FIGS. 1 and 2 are well proven and optimized for the production of Li₂CO₃ and LiOH—H₂O, by conversion reaction of Li₂SO₄ with Na₂CO₃ or NaOH, respectively. It would therefore be desirable to maintain these conversion reactions, while improving upon the processes to address the aforementioned issues.

Accordingly, there is a need in the art for methods of processing spodumene or other lithium containing materials and solutions to produce lithium materials that avoid or reduce production of the Na₂SO₄ byproduct, and that produce higher value byproducts instead. It would be desirable for such methods to increase the recovery of lithium by the method, reduce the amount of required reagent and energy inputs, and reduce CO₂ gas emissions relative to prior art methods.

### SUMMARY

In accordance with a broad aspect of the present disclosure, there is provided a method of processing a lithium containing material, to produce a primary lithium product and to produce at least one byproduct, the method comprising the steps of: (a) preparing an aqueous feed solution comprising lithium sulfate by reacting the lithium-containing material with sulfuric acid; (b) reacting the feed solution with a primary reagent to produce a mixed solution comprising the primary lithium product and sodium sulfate; (c) separating the primary lithium product from the mixed solution, and producing a separated sodium sulfate solution from the mixed solution; and (d) performing a conversion process on the separated sodium sulfate solution to produce the byproduct.

In embodiments, there is provided a method of processing a lithium-containing material to produce a primary lithium product and to produce a byproduct, the method comprising the steps of: (a) preparing an aqueous feed solution comprising lithium sulfate by reacting the lithium-containing material with sulfuric acid; (b) reacting the aqueous feed solution with a primary reagent to produce a mixed solution comprising the primary lithium product and sodium sulfate, wherein either: (i) the primary reagent comprises sodium carbonate and the primary lithium product comprises lithium carbonate; or (ii) the primary reagent comprises sodium hydroxide and the primary lithium product comprises lithium hydroxide; (c) separating the primary lithium product from the mixed solution, and producing a separated sodium sulfate solution from the mixed solution, wherein: (i) if the primary lithium product comprises lithium carbonate, then: (A) separating the primary lithium product from the mixed solution comprises precipitating the lithium carbonate from the mixed solution; and (B) the separated sodium sulfate solution comprises a solution remaining after precipitating the lithium carbonate in sub-step (c)(i)(A); or (ii) if the primary lithium product comprises lithium hydroxide, then: (A) producing the separated sodium sulfate solution from the mixed solution comprises separating decahydrate of sodium sulfate from the mixed solution, and dissolving the separated decahydrate of sodium sulfate in water; and (B) separating the primary lithium product from the mixed solution comprises crystallizing the lithium hydroxide from a solution remaining after separating the decahydrate of sodium sulfate from the mixed solution in sub-step (c)(ii)(A); and (d) performing a conversion process on the separated sodium sulfate solution to produce the byproduct, the conversion process comprising: (i) reacting the separated sodium sulfate solution with a salt chemical, wherein either: the salt chemical comprises calcium nitrate, and the byproduct comprises calcium sulfate and sodium nitrate; the salt chemical comprises barium chloride and the byproduct comprises barium sulfate and sodium chloride; the salt chemical comprises calcium chloride and the byproduct comprises calcium sulfate and sodium chloride; the salt chemical comprises copper nitrate and the byproduct comprises copper sulfate and sodium nitrate; the salt chemical comprises nickel chloride and the byproduct comprises nickel sulfate and sodium chloride; the salt chemical comprises nickel nitrate and the byproduct comprises nickel sulfate and sodium nitrate; or the salt chemical comprises potassium carbonate, and the byproduct comprises potassium sulfate and sodium carbonate; or (ii) reacting the separated sodium sulfate solution with an alkali chemical, wherein either: the alkali chemical comprises calcium hydroxide, and the byproduct comprises calcium sulfate and sodium hydroxide; the alkali chemical comprises ammonium hydroxide, and the byproduct comprises ammonium sulfate and sodium hydroxide; the alkali chemical comprises barium hydroxide, and the byproduct comprises barium sulfate and sodium hydroxide; or the alkali chemical comprises potassium hydroxide, and the byproduct comprises potassium sulfate and sodium hydroxide; or (iii) using the separated sodium sulfate solution as an electrolyte in either an electrolysis process or an electrodialysis process, and the byproduct comprises sodium hydroxide and sulfuric acid.

In accordance with a further aspect of the present disclosure, there is provided a method of processing an aqueous feed solution comprising lithium sulfate to produce a primary lithium product and to produce at least one byproduct, the method comprising the steps (b) through (d) as set out above. In embodiments of the method, the method comprises the further step of preparing the aqueous feed solution by reacting a lithium-containing material with sulfuric acid.

In embodiments, there is provided a method of processing an aqueous feed solution comprising lithium sulfate to produce a primary lithium product and to produce a byproduct, the method comprising the steps of: (a) reacting the aqueous feed solution with a primary reagent to produce a mixed solution comprising the primary lithium product and a sodium sulfate solution, wherein either: (i) the primary reagent comprises sodium carbonate and the primary lithium product comprises lithium carbonate; or (ii) the primary reagent comprises sodium hydroxide and the primary lithium product comprises lithium hydroxide; (b) separating the primary lithium product from the mixed solution, and producing a separated sodium sulfate solution from the mixed solution, wherein: (i) if the primary lithium product comprises lithium carbonate, then: (A) separating the primary lithium product from the mixed solution comprises precipitating the lithium carbonate from the mixed solution; and (B) the separated sodium sulfate solution comprises a solution remaining after precipitating the lithium carbonate in sub-step (b)(i)(A); or (ii) if the primary lithium product comprises lithium hydroxide, then: (A) producing the separated sodium sulfate solution from the mixed solution comprises separating decahydrate of sodium sulfate from the mixed solution, and dissolving the separated decahydrate of sodium sulfate in water; and (B) separating the primary lithium product from the mixed solution comprises crystallizing the lithium hydroxide from a solution remaining after separating the decahydrate of sodium sulfate from the mixed solution in sub-step (b)(ii)(A); and (c) performing a conversion process on the separated sodium sulfate solution to produce the byproduct, the conversion process comprising: (i) reacting the separated sodium sulfate solution with a salt chemical, wherein either: the salt chemical comprises calcium nitrate, and the byproduct comprises calcium sulfate and sodium nitrate; the salt chemical comprises barium chloride and the byproduct comprises barium sulfate and sodium chloride; the salt chemical comprises calcium chloride and the byproduct comprises calcium sulfate and sodium chloride; the salt chemical comprises copper nitrate and the byproduct comprises copper sulfate and sodium nitrate; the salt chemical comprises nickel chloride and the byproduct comprises nickel sulfate and sodium chloride; the salt chemical comprises nickel nitrate and the byproduct comprises nickel sulfate and sodium nitrate; or the salt chemical comprises potassium carbonate, and the byproduct comprises potassium sulfate and sodium carbonate; or (ii) reacting the separated sodium sulfate solution with an alkali chemical, wherein either: the alkali chemical comprises calcium hydroxide, and the byproduct comprises calcium sulfate and sodium hydroxide; the alkali chemical comprises ammonium hydroxide, and the byproduct comprises ammonium sulfate and sodium hydroxide; the alkali chemical comprises barium hydroxide, and the byproduct comprises barium sulfate and sodium hydroxide; or the alkali chemical comprises potassium hydroxide, and the byproduct comprises potassium sulfate and sodium hydroxide; or (iii) using the separated sodium sulfate solution as an electrolyte in either an electrolysis process or an electrodialysis process, and the byproduct comprises sodium hydroxide and sulfuric acid.

In embodiments, the lithium-containing material may comprise a mineral. In such embodiments, the method may comprise subjecting the mineral to a calcination process for phase conversion of the mineral before preparing the feed solution. Preparing the feed solution may comprise sulfuric acid roasting the mineral to prepare an acid-roasted mineral. The mineral may be spodumene, or another mineral such as petalite, lepidolite, zinnwaldite, amblygonite, eucryptite, hectorite, a lithium clay, jadarite and so on. In addition or alternatively, the lithium-containing material may comprise low grade lithium carbonate, or material from lithium battery recycling.

In an embodiment and in accordance with an aspect of the present methods, the primary reagent may comprise sodium carbonate and the primary lithium product comprises lithium carbonate. In such embodiments, separating the primary lithium product from the mixed solution comprises precipitating the lithium carbonate from the mixed solution; and the separated sodium sulfate solution comprises a solution remaining after precipitating the lithium carbonate, as described above.

In an embodiment and in accordance with an aspect of the present methods, the primary reagent may comprise sodium hydroxide and the primary lithium product comprises lithium hydroxide. In such embodiments, producing the separated sodium sulfate solution from the mixed solution comprises separating decahydrate of sodium sulfate from mixed solution, and dissolving the separated decahydrate of sodium sulfate in water; and separating the primary lithium product comprises crystallizing the lithium hydroxide from a solution remaining after separating the decahydrate of sodium sulfate from the mixed solution, as described above.

In an embodiment and in accordance with an aspect of the present methods, the conversion process may comprise reacting the separated sodium sulfate solution with the salt chemical, wherein either: the salt chemical comprises calcium nitrate, and the byproduct comprises calcium sulfate and sodium nitrate; the salt chemical comprises barium chloride and the byproduct comprises barium sulfate and sodium chloride; the salt chemical comprises calcium chloride and the byproduct comprises calcium sulfate and sodium chloride; the salt chemical comprises copper nitrate and the byproduct comprises copper sulfate and sodium nitrate; the salt chemical comprises nickel chloride and the byproduct comprises nickel sulfate and sodium chloride; the salt chemical comprises nickel nitrate and the byproduct comprises nickel sulfate and sodium nitrate; or the salt chemical comprises potassium carbonate, and the byproduct comprises potassium sulfate and sodium carbonate. In such embodiments, the separated sodium sulfate solution or a solution resulting from the conversion process may comprise residual lithium from the feed solution, and the method may comprise the further step of reacting the residual lithium with a secondary reagent comprising phosphoric acid to produce a secondary lithium product comprising lithium phosphate.

In an embodiment and in accordance with an aspect of the present methods, the conversion process may comprise reacting the separated sodium sulfate solution with an alkali chemical, wherein either: the alkali chemical comprises calcium hydroxide, and the byproduct comprises calcium sulfate and sodium hydroxide; the alkali chemical comprises ammonium hydroxide, and the byproduct comprises ammonium sulfate and sodium hydroxide; the alkali chemical comprises barium hydroxide, and the byproduct comprises barium sulfate and sodium hydroxide; or the alkali chemical comprises potassium hydroxide, and the byproduct comprises potassium sulfate and sodium hydroxide. In such embodiments, the separated sodium sulfate solution or a solution resulting from the conversion process may comprise residual lithium from the feed solution, and the method may comprise the further step of reacting the residual lithium with a secondary reagent comprising carbon dioxide to produce a secondary lithium product comprising lithium carbonate, or with a secondary reagent comprising phosphoric acid to produce a secondary lithium product comprising lithium phosphate. The carbon dioxide may be separated from a flue gas produced by combustion of a fossil fuel used to produce heat for the sulfuric acid roasting of a lithium-containing mineral that is used to produce the feed solution, or a calcination process for phase conversion of a lithium-containing mineral that is used to produce the feed solution, or for generating steam for use in a plant used to implement the method. In such embodiments, the method may comprise the further step of: using at least a first portion of the byproduct comprising sodium hydroxide to treat further feed solution by removing non-lithium impurities from the further feed solution, in continued performance of the method; and/or reacting at least a second portion of the byproduct comprising sodium hydroxide with further feed solution to produce further primary lithium product comprising further lithium hydroxide in continued performance of the method.

In an embodiment and in accordance with an aspect of the present methods, the conversion process may comprise using the separated sodium solution as an electrolyte in either an electrolysis process or an electrodialysis process, and the byproduct comprises sodium hydroxide and sulfuric acid. In such embodiments, the method may comprise the further step(s) of: using at least a first portion of the byproduct comprising sodium hydroxide to treat further feed solution by removing non-lithium impurities from the further feed solution, in continued performance of the method; and/or reacting at least a second portion of the byproduct comprising sodium hydroxide with further feed solution to produce further primary lithium product comprising further lithium hydroxide in continued performance of the method. In such embodiments, the method may comprise the further step of reacting at least a portion of the byproduct comprising sulfuric acid with further lithium-containing material to produce further feed solution in continued performance of the method. In such embodiments, the electrolysis process or the electrodialysis process may produce a bleed liquor comprising sodium sulfate, and the method may further comprise the step of using the bleed liquor to produce further feed solution in continued performance of the method.

Additional aspects, advantages and features of the present invention will become more apparent upon reading of the following non-restrictive description of preferred embodiments which are exemplary and should not be interpreted as limiting the scope of the invention.

### BRIEF DESCRIPTION OF THE DRAWINGS

In the drawings, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

Further features and advantages of the present disclosure will become apparent from the following detailed description, taken in combination with the appended drawings, in which:

FIG. 1 is a flow chart of a method for processing α-spodumene concentrate to produce a Li₂CO₃ lithium product, and Na₂SO₄ byproduct known in the prior art.

FIG. 2 is a flow chart of a method for processing α-spodumene concentrate to produce a LiOH—H₂O lithium product, and Na₂SO₄ byproduct, known in the prior art.

FIG. 3 is a flow chart for an embodiment of a method of the present invention for processing α-spodumene concentrate to produce a Li₂CO₃ primary lithium product, CaSO₄ and NaNO₃ byproducts by reaction of a Na₂SO₄ intermediate product with a salt chemical, and Li₃PO₄ secondary lithium products.

FIG. 4 is a flow chart for an embodiment of a method of the present invention for processing α-spodumene concentrate to produce a LiOH—H₂O primary lithium product, CaSO₄ and NaNO₃ byproducts by reaction of a Na₂SO₄ intermediate product with a salt chemical, and optionally Li₃PO₄ secondary lithium products.

FIG. 5 is a flow chart for an embodiment of a method of the invention for processing α-spodumene concentrate to produce a Li₂CO₃ primary lithium product, CaSO₄ and NaOH byproducts by reaction of a Na₂SO₄ intermediate product with an alkali chemical, and optionally Li₂CO₃ or Li₃PO₄ secondary lithium products.

FIG. 6 is a flow chart for an embodiment of a method of the present invention for processing α-spodumene concentrate to produce a LiOH—H₂O primary lithium product, CaSO₄ and NaOH byproducts by the reaction of a Na₂SO₄ intermediate product with an alkali chemical, and optionally Li₂CO₃ or Li₃PO₄ secondary lithium products.

FIG. 7 is a flow chart for an embodiment of a method of the present invention for processing α-spodumene concentrate to produce a Li₂CO₃ primary lithium product, and NaOH and H₂SO₄ byproducts by electrolysis or electrodialysis of a Na₂SO₄ intermediate product.

FIG. 8 is a schematic diagram illustrating Na₂SO₄ conversion to NaOH and H₂SO₄ with an embodiment of an electrolysis process that may be used according to the method illustrated in FIG. 7 or FIG. 10.

FIG. 9 is a schematic diagram illustrating Na₂SO₄ conversion to NaOH and H₂SO₄ with an embodiment of a bipolar membrane electrodialysis (BMED) method that may be used according to the method illustrated in FIG. 7 or FIG. 10.

FIG. 10 is a flow chart for an embodiment of a method of the present invention for processing α-spodumene concentrate to produce a LiOH—H₂O primary lithium product, NaOH and H₂SO₄ byproducts by electrolysis or electrodialysis of a Na₂SO₄ intermediate product.

### DETAILED DESCRIPTION OF EMBODIMENTS

### Overview

Example methods and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

The present disclosure relates to processing a material containing lithium, such as hard rock comprising lithium to produce either lithium carbonate (Li₂CO₃) or lithium hydroxide monohydrate (LiOH—H₂O), or both of them. Any term or expression not expressly defined herein shall have its commonly accepted definition understood by a person skilled in the art.

In a broad aspect, in embodiments, the present disclosure provides a method of processing a material containing lithium, such as hard rock lithium minerals like α-spodumene to produce a primary lithium product comprising either lithium carbonate (Li₂CO₃) or lithium hydroxide monohydrate (LiOH—H₂O), and a byproduct by conversion of a sodium sulfate (Na₂SO₄) intermediate product. In general, the method comprises the steps of: (a) preparing an aqueous feed solution comprising lithium sulfate by reacting the lithium-containing material with sulfuric acid; (b) reacting the feed solution with a primary reagent to produce a mixed solution of the primary lithium product and a sodium sulfate solution; (c) separating the primary lithium product from the mixed solution, and producing a separated sodium sulfate solution (e.g., either as a result of separating the primary lithium product from the mixed solution by precipitation, or by separating decahydrate of sodium sulfate from the mixed solution and dissolving the separated decahydrate of sodium sulfate in water); and (d) performing a conversion process on the separated sodium sulfate solution to produce the byproduct.

### EXAMPLES

The following examples provide embodiments of the methods of the present disclosure, as applied to processing α-spodumene concentrate. The following example are not limitative in nature.

In the following examples, a “feed solution” of aqueous solution comprising Li₂SO₄ may be produced by leaching of material produced by acid-roasting of β-spodumene, which is produced by calcination of α-spodumene concentrate. It will be understood that this is a non-limiting embodiment of how this “feed solution” may be produced, and that the present disclosure may be applied to such solutions formed by other processes, as described below.

In an embodiment, a Li₂SO₄ feed solution may be derived from low grade lithium carbonate product, which can be obtained from the brine lithium industry. The low grade lithium carbonate may be reacted with H₂SO₄ to produce the Li₂SO₄ feed solution.

In another embodiment, the Li₂SO₄ feed solution may be derived from used battery materials, which may be obtained from the battery recycling industry. The used battery materials may be reacted with H₂SO₄ and be leached to produce Li₂SO₄ feed solution.

In another embodiment, the Li₂SO₄ feed solution may be derived from lithium extracted from hard rock minerals, other than spodumene, such as petalite, lepidolite, zinnwaldite, amblygonite, and eucryptite, and non-hard rock minerals such as hectorite, lithium clays, jadarite and so on. Lithium can be extracted from these minerals using a H₂SO₄ process similar to extracting lithium from spodumene to produce the Li₂SO₄ feed solution. Depending on the mineral, calcination, i.e. phase conversion, and/or acid roasting of the mineral may or may not be required.

It will be understood that the methods may be performed on a batch basis (i.e., the steps are performed once in sequence for a batch of α-spodumene concentrate), or on a continuous basis (e.g., the steps are performed continuously and simultaneously as further α-spodumene concentrate is continuously processed to continuously produce further feed solution, to continuously produce further primary lithium product).

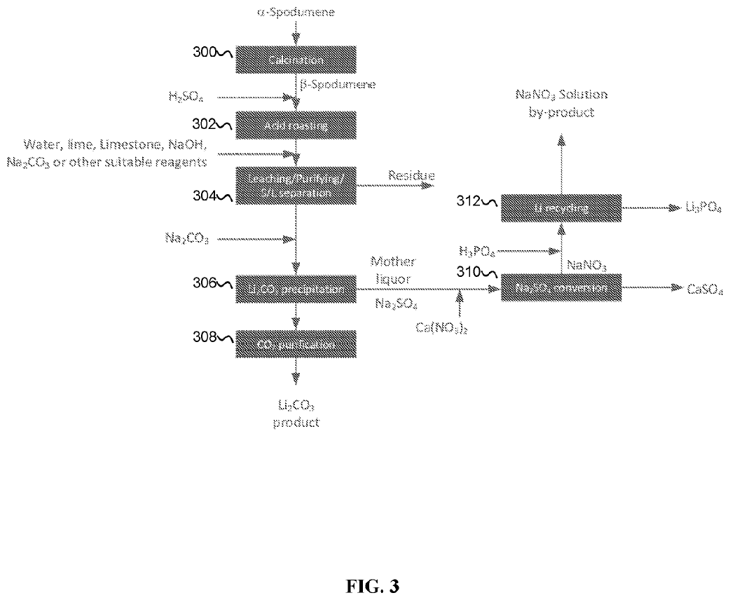

FIGS. 3 to 7 and 10, as described below, are flow charts showing steps of embodiments of the methods of the present disclosure. With the benefit of such flow charts, the person skilled in the art will be able to carry out processes of the described methods using equipment known in the art, such as rotary kiln, various reactors, tanks, thickener, centrifuge, various filters, various driers, ion exchange, water treatment equipment, crystallizer, and other separation equipment, heating equipment, electrolytic cells, electrodialysis cells, and so forth, as may be needed.

### Example No. 1: Production of Li₂CO₃ Primary Lithium Product, and CaSO₄ and NaNO₃ Byproducts by Reaction of Na₂SO₄ with a Salt Chemical

FIG. 3 represents a flow chart for an embodiment of a method of the present invention for processing α-spodumene concentrate to produce a Li₂CO₃ primary lithium product, CaSO₄ and NaNO₃ byproducts, and Li₃PO₄ secondary lithium products. In this example, the CaSO₄ and NaNO₃ byproducts are produced by reaction of a sodium sulfate (Na₂SO₄) intermediate product with a salt chemical of calcium nitrate (Ca(NO₃)₂).

Although Ca(NO₃)₂ is used as the salt chemical in this example, it will be understood that other salt chemicals of the group consisting of barium chloride (BaCl₂), calcium chloride (CaCl₂)), copper nitrate (Cu(NO₃)₂), nickel chloride (NiCl₂), nickel nitrate (Ni(NO₃)₂), potassium carbonate (K₂CO₃), and mixtures thereof, may be used instead of Ca(NO₃)₂.

The reaction of these other salt chemicals with Na₂SO₄ will produce different byproducts, as noted in Table 1 below. These other salt chemicals and byproducts are within the scope of the invention.

TABLE 1

| Salt chemical | Byproducts from reaction with Na₂SO₄ |
|---|---|
| barium chloride (BaCl₂) | barium sulfate (BaSO₄) and sodium chloride (NaCl) |
| calcium chloride (CaCl₂) | calcium sulfate (CaSO₄) and sodium chloride (NaCl) |
| calcium nitrate Ca(NO₃)₂ | calcium sulfate (CaSO₄) and sodium nitrate (NaNO₃) |
| copper nitrate (Cu(NO₃)₂) | copper sulfate (CuSO₄) and sodium nitrate (NaNO₃) |
| nickel chloride (NiCl₂) | nickel sulfate (NiSO₄) and sodium chloride (NaCl) |
| nickel nitrate (Ni(NO₃)₂) | nickel sulfate (NiSO₄) and sodium nitrate (NaNO₃) |
| potassium carbonate (K₂CO₃) | potassium sulfate (K₂SO₄) and sodium carbonate |
| | (Na₂CO₃) |

At step 300, solid α-spodumene concentrate may be converted to β-spodumene by calcination in a rotary kiln. Calcination is typically performed at temperatures of above 900° C. to convert α-spodumene to β-spodumene, but the present invention is not limited by a particular temperature.

At step 302, the produced β-spodumene is mixed with sulfuric acid (H₂SO₄) and subjected to acid roasting. Roasting is typically performed at temperatures of about 250° C. to form water soluble lithium sulfate (Li₂SO₄), but the present invention is not limited by a particular temperature.

In steps 300 and 302, the heat required by kiln calcination and acid roasting is produced by combustion of fossil fuels in the current lithium extraction industry. This produces flue gases, including CO₂ gas, which may be diverted for use in the process as described below, rather than emitted into the atmosphere.

At step 304, the acid-roasted material is mixed with water in leaching tanks where lithium and other metal impurities are leached into solution. For solution purification, generally, limestone powder (CaCO₃), lime (CaO) or hydrated lime (Ca(OH)₂), NaOH, Na₂CO₃ or any other reagent which can precipitate impurities is or are added into the solution to change the pH and remove impurities and the overdosed SO₄²⁻ in acid roasting. By solid/liquid (S/L) separation, leaching residue and impurity residue may be separated and PLS (pregnant leach solution) solution is obtained. If necessary, an ion exchange (IX) circuit may be further used to remove Ca and Mg impurities. By this purification, clean PLS solution comprising Li₂SO₄ is obtained. Step 304 results in the production of aqueous solution comprising lithium sulfate (Li₂SO₄), which is considered to be an example of a “feed solution” in the present invention.

At step 306, sodium carbonate (Na₂CO₃) solution may be added to the PLS solution comprising Li₂SO₄. The Li₂SO₄ PLS reacts with Na₂CO₃ to precipitate lithium carbonate (Li₂CO₃) in a Na₂SO₄ solution. The produced Li₂CO₃ can be separated from the sodium sulfate solution by precipitation at a temperature, for example being about 95° C. (The solubility of Li₂CO₃ decreases as the temperature of the solution increases.) The precipitated Li₂CO₃ may be separated from a mother liquor and dried as Li₂CO₃ product. The Na₂CO₃ may be considered to be an example of a “primary reagent” in the present invention, and the Li₂CO₃ may be considered to be an example of a “primary lithium product” in the present invention.

If battery-grade product is desired, then the wet Li₂CO₃ cake obtained may be re-dissolved and, at step 308, further purified by a CO₂ method, known in the prior art. In general, the aforementioned CO₂ method involves reacting Li₂CO₃ product with CO₂ to produce soluble LiHCO₃. Insoluble impurities, such as iron, magnesium, and calcium may be removed from the solution. The CO₂ may be then removed, such as by increasing the temperature of the solution, to precipitate pure Li₂CO₃. The wet Li₂CO₃ obtained after filtration is dried to produce a final battery-grade Li₂CO₃ product. Magnetic impurity removal in some parts of process and micronizing steps to reduce the Li₂CO₃ product to a desired particle size before final packing may be performed on the Li₂CO₃ product.

The mother liquor that was separated from the precipitated Li₂CO₃ at step 306 comprises Na₂SO₄.

At step 310, the mother liquor may be mixed with calcium nitrate (Ca(NO₃)₂) so that the Na₂SO₄ of the mother liquor and the Ca(NO₃)₂ react to convert the Na₂SO₄ to calcium sulfate (CaSO₄) and sodium nitrate (NaNO₃, which may be represented by the following equation:

$${Na}_{2} {SO}_{4 ( aq )} + C {a ( N {O}_{3} )}_{2} \to {CaSO}_{4 ( s )} ↓ + 2 NaN {O}_{3 ( aq )} \qquad ( Eqn . 1 )$$

The CaSO₄ and NaNO₃ may be considered to be an example of a “byproduct” in the present invention. This reaction of Eqn. 1 may take place at a variety of combinations of pressure and temperature, including at atmospheric pressure and room temperature (i.e., about 20° C.). In embodiments, Ca(NO₃)₂ may be introduced into the vessel in solid form. In other embodiments, Ca(NO₃)₂ may be introduced into the vessel in aqueous solution, as Ca(NO₃)₂ has relatively high solubility in water. The CaSO₄ precipitates as a solid, as it has relatively low solubility in water at room temperature. The NaNO₃ remains in solution, as it has relatively high solubility in water at room temperature.

For the Na₂SO₄ conversion reaction, the Na₂SO₄ concentration in the solution or slurry may be 5 to 35 wt %, and the Ca(NO₃)₂/Na₂SO₄ molar ration may be 0.8 to 2, and the resulted conversion rate may be in 70% to 99%. Preferably, the Na₂SO₄ concentration in the solution or slurry may be between 10 to 30 wt %, and the Ca(NO₃)₂/Na₂SO₄ molar ration may be between 1 to 1.6, and the resulted conversion rate may be between 85 to 99%. Most preferably, the Na₂SO₄ concentration in the solution or slurry may be between 15 to 25 wt %, and the Ca(NO₃)₂/Na₂SO₄ molar ration may be between 1 to 1.1, and the resulted conversion rate may be between 90 to 97%. The precipitated CaSO₄ may be separated from NaNO₃ solution with regular, low cost equipment, with non-limiting examples including clarifiers, thickeners for gravity settling, or mechanical filters. In embodiments, the NaNO₃ may be left to remain in solution.

In embodiments, if NaNO₃ in solid form is desired, the NaNO₃ may be crystallized by evaporation using a crystallization circuit, and condensed water produced from the crystallization circuit can be re-used in the process at step 304.

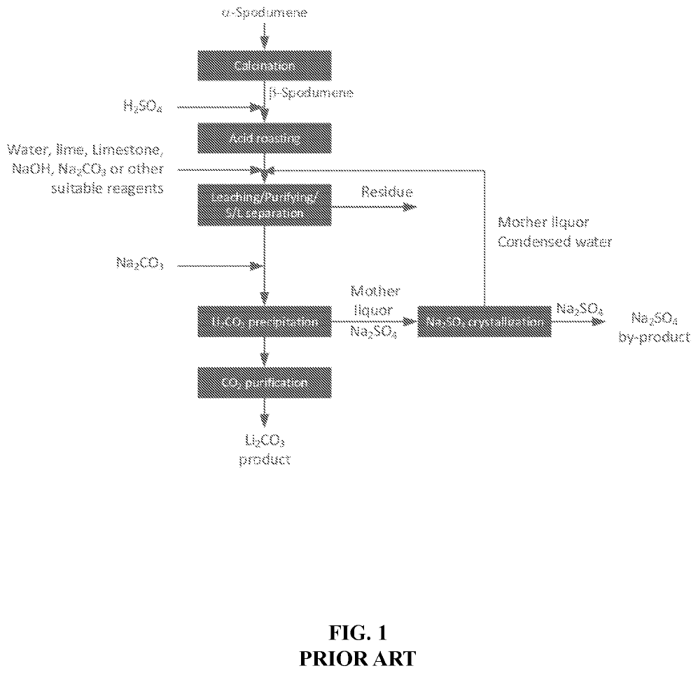

In comparison with the prior art process shown in FIG. 1, a person skilled in the art would appreciate that the method shown in FIG. 3 may be advantageous as follows. First, a crystallization circuit for treating the Na₂SO₄ may be avoided or at least be reduced in capacity, thus reducing its associated capital and operating cost. Second, in comparison with Na₂SO₄, CaSO₄ and NaNO₃ typically have a higher market value and different industrial applications. For example, CaSO₄ may be used as construction material, or as a feed material for cement production. NaNO₃ may be used as fertilizer in agriculture or as explosive in mining industries and construction industries. Third, NaNO₃ may also be kept in a solution form for sale to market. As illustrated, the embodiment according to the instant disclosure can significantly reduce the energy consumption of the overall process by avoiding the need for evaporation.

The solution resulting from step 310 may contain residual lithium. In step 312, the residual lithium may be recycled to produce a lithium material that is additional to the Li₂CO₃ produced in step 308. This increases the total recovery of lithium produced by the instant method.

In embodiments, at step 312, phosphoric acid (H₃PO₄) may be added to the solution resulting from step 310. The phosphate ions, PO₄³⁻ will react with the lithium ions Lit in the solution to form lithium phosphate (Li₃PO₄), as follows.

$$3 {Li}_{( aq )}^{+} + {PO}_{4 ( aq )}^{3 -} \to {Li}_{3} P {O}_{4 ( s )} ↓ \qquad ( Eqn . 2 )$$

The H₃PO₄ may be considered to be an example of a “secondary reagent” in the present invention, and the Li₃PO₄ may be considered to be an example of a “secondary lithium product” in the present invention. Li₃PO₄ has poor solubility in water at room temperature, and will precipitate as a solid. Li₃PO₄ is another important feed material for production of lithium batteries.

In embodiments, and as illustrated in FIG. 3, step 312 is shown as being performed after step 310. In other embodiments, step 312 may be performed directly on the mother liquor resulting from step 306, before performing step 310. It will be appreciated that this alternative embodiment is within the scope of the present invention.

### Example No. 2: Production of LiOH—H₂O Primary Lithium Product, and CaSO₄ and NaNO₃ Byproducts by Reaction of Na₂SO₄ with a Salt Chemical

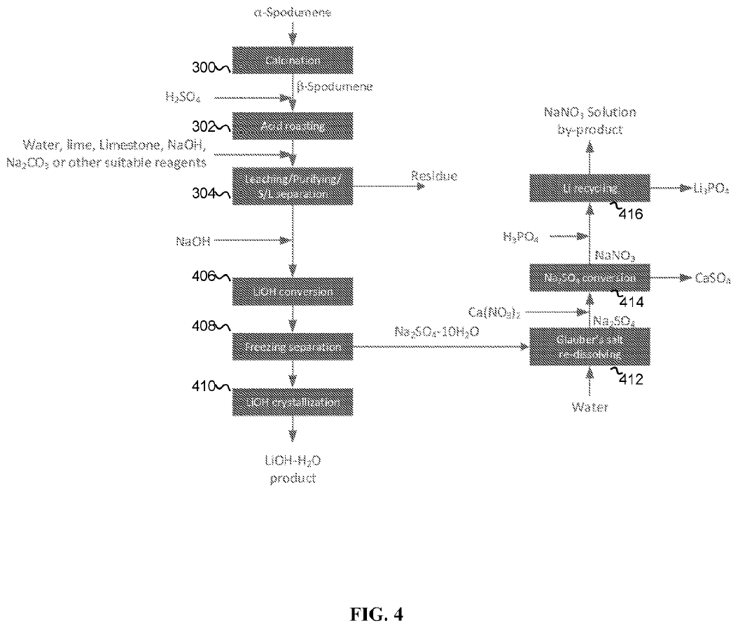

FIG. 4 represents a flow chart of an embodiment of the present invention, there is provided a method for processing α-spodumene concentrate to produce a LiOH—H₂O primary lithium product, and CaSO₄ solid and NaNO₃ solution byproducts, and optionally Li₃PO₄ secondary lithium products. In this example, the CaSO₄ and NaNO₃ byproducts are produced by reaction of a sodium sulfate (Na₂SO₄) intermediate product with a salt chemical of Ca(NO₃)₂. As noted above in respect to the method of FIG. 3, although Ca(NO₃)₂ is used as the salt chemical in this example, it will be understood that other salt chemicals may be used to produce other byproducts. Some of the salt chemicals are summarized in the Table 1, above.

In the method of FIG. 4, steps 300, 302, 304 are analogous to the same numbered steps of the method illustrate in FIG. 3. As such, the description of those steps applies to the respective analogous step in the method of FIG. 4, with the necessary adjustments.

As to step 406 of FIG. 4, NaOH may be added to the PLS solution comprising Li₂SO₄. The Li₂SO₄ PLS reacts with NaOH to form a solution of a mixture of LiOH and Na₂SO₄, as shown below. The NaOH may be considered to be an example of a “primary reagent” in the present invention, and the LiOH or LiOH—H₂O may be considered to be an example of a “primary lithium product” in the present invention, this Na₂SO₄ solution may be referred to as an “intermediate solution” in the present invention, to distinguish it from the feed solution.

$$L {i}_{2} {SO}_{4 ( a q )} + 2 {NaOH}_{( a q )} \to {Na}_{2} {SO}_{4 ( a q )} + 2 {LiOH}_{( a q )} \qquad ( Eqn . 3 )$$

At step 408 of FIG. 4, the solution resulting from step 406 may be subjected to freezing treatment by lowering its temperature. The solubility of LiOH at freezing temperatures is greater than the solubility of Na₂SO₄ at freezing temperatures in the rage between 0° C. and −15° C. Thus, as a result of the freezing treatment, Na₂SO₄ may be separated from solution in the form of the decahydrate of sodium sulfate (Na₂SO₄-10H₂O), which is known as Glauber's salt.

At step 410 of FIG. 4, the Na₂SO₄-removed LiOH PLS solution resulting from step 408 may be subjected to crystallization to produce a wet LiOH cake.

The wet LiOH cake may be dried to produce a final LiOH—H₂O product. If battery-grade product is desired, the produced wet LiOH cake may be re-dissolved and subjected to secondary or tertiary crystallization, as required. Usually, magnetic impurity removal in some parts of process and micronizing before packaging may be performed for battery grade product.

At step 412 of FIG. 4, the Glauber's salt that is produced from the freezing separation process of step 408 may be re-dissolved in water to produce a solution of Na₂SO₄.

At step 414 of FIG. 4, the solution of Na₂SO₄ resulting from step 412 may be mixed with Ca(NO₃)₂ so that the Na₂SO₄ and the Ca(NO₃)₂ react to convert the Na₂SO₄ to CaSO₄ and NaNO₃ (see Eqn. 1). This reaction is analogous to the reaction described above in step 310 of the method as illustrated in FIG. 3. As such, it will be understood that such description applies in the context of step 414 of FIG. 4. The CaSO₄ and NaNO₃ may be considered to be an example of a “byproduct” in the present invention.

The solution resulting from step 414 may contain residual lithium. In step 416, this residual lithium may be recycled to produce lithium materials that are additional to the LiOH produced in step 410. This increases the total recovery of lithium produced by the method as illustrated in FIG. 4.

In an embodiment and as illustrated in step 416 of FIG. 4, phosphoric acid (H₃PO₄) may be added to the solution resulting from step 414 to yield Li₃PO₄. These reactions are analogous to the reactions described above in step 312 of the method illustrated in FIG. 3. As such, it will be understood that such description applies in the context of step 416 of FIG. 4.

In an embodiment illustrated in FIG. 4, step 416 may be performed after step 414. In other embodiments, step 416 may be performed directly on the solution resulting from step 412, and before performing 414. This alternative embodiment is within the scope of the present invention.

### Example No. 3: Production of Li₂CO₃ Lithium Product, and CaSO₄ and NaOH Byproducts by Reaction of Na₂SO₄ with an Alkali Chemical

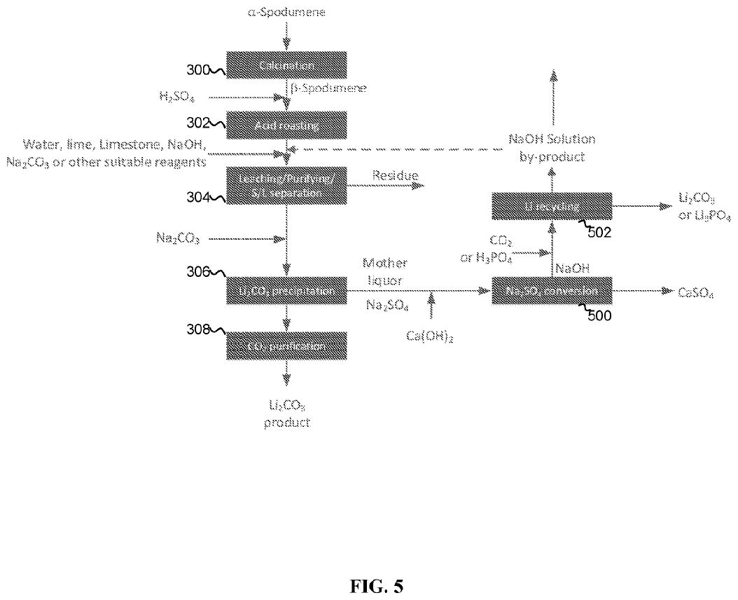

FIG. 5 represents a flow chart for an embodiment of a method of the present invention for processing α-spodumene concentrate to produce a Li₂CO₃ primary lithium product, CaSO₄ and NaOH byproducts, and optionally Li₂CO₃ or Li₃PO₄ secondary lithium products. In this example, the CaSO₄ and NaOH byproducts may be produced by reaction of a sodium sulfate (Na₂SO₄) intermediate product with an alkali chemical of calcium hydroxide (Ca(OH)₂).

Although Ca(OH)₂ is used as the alkali chemical in this example and as illustrated in FIG. 5, it will be understood that other alkali chemicals selected from the group consisting of ammonium hydroxide (NH₄OH), barium hydroxide (Ba(OH)₂), potassium hydroxide (KOH), and mixtures of any of the foregoing, may be used instead of Ca(OH)₂. The reaction of these other alkali chemicals with Na₂SO₄ may produce different byproducts, as noted in Table 2 below.

TABLE 2

| Alkali chemical | Byproducts from reaction with Na₂SO₄ |
|---|---|
| ammonium hydroxide (NH₄OH) | ammonium sulfate ((NH₄)₂SO₄) and sodium hydroxide |
| | (NaOH) |
| barium hydroxide (Ba(OH)₂) | barium sulfate (BaSO₄) and sodium hydroxide (NaOH) |
| calcium hydroxide Ca(OH)₂ | calcium sulfate (CaSO₄) and sodium hydroxide |
| | (NaOH) |
| potassium hydroxide (KOH) | potassium sulfate (K₂SO₄) and sodium hydroxide |
| | (NaOH) |

In the method as illustrated in FIG. 5, steps 300, 302, 304, 306, 308 are analogous to the same numbered steps of the method as illustrated FIG. 3. As such, it will be understood that description of those steps applies to the respective analogous step in the method of FIG. 5.

The mother liquor that was separated from the precipitated Li₂CO₃ at step 306 comprises Na₂SO₄. At step 500, the mother liquor may be mixed with Ca(OH)₂ so that the Na₂SO₄ of the mother liquor and the Ca(OH)₂ react to convert the Na₂SO₄ to CaSO₄ solid and NaOH solution as follows.

$${Na}_{2} {SO}_{4 ( aq )} + Ca {( OH )}_{2 ( aq )} \to {CaSO}_{4 ( s )} ↓ + 2 {NaOH}_{( aq )} \qquad ( Eqn . 4 )$$

The CaSO₄ and NaOH may be considered to be an example of a “byproduct” in the present invention. This reaction may take place at a variety of combinations of pressure and temperature, including at atmospheric pressure and room temperature (i.e., about 20° C.). The CaSO₄ precipitates as a solid since it has relatively low solubility in water at room temperature. The NaOH remains in solution as it has relatively high solubility in water at room temperature. For the Na₂SO₄ conversion reaction, the Na₂SO₄ concentration in the solution or slurry can be 5 to 35 wt %, and the Ca(OH)₂/Na₂SO₄ molar ration can be 0.7 to 2.5, and the resulted conversion rate can be in 60% to 98% Preferably, the Na₂SO₄ concentration in the solution or slurry may be between 10 to 30 wt %, and the Ca(OH)₂/Na₂SO₄ molar ration may be between 0.9 to 2, and the resulted conversion rate may be between 70 to 96%. Most preferably, the Na₂SO₄ concentration in the solution or slurry may be between 15 to 25 wt %, and the Ca(OH)₂/Na₂SO₄ molar ration may be between 1 to 1.5, and the resulted conversion rate may be between 85 to 95%. The precipitated CaSO₄ may be separated from NaOH solution with regular, low cost equipment, with non-limiting examples including clarifiers or thickeners for gravity settling, or mechanical filters. In embodiments, the NaOH may be left to remain in solution. In other embodiments, if NaOH in solid form is desired, the NaOH may be crystallized by evaporation using a crystallization circuit, and condensed water produced from the crystallization circuit can be re-used in the process at step 304.

In comparison with the prior art process shown in FIG. 1, the same relative advantages noted in respect to the method of FIG. 3 apply equally to the method of FIG. 5, albeit substituting the NaOH solution product in the method of FIG. 5 for NaNO₃ product in the method of FIG. 3. NaOH typically has higher market value than the feeding Na₂SO₄ and the Ca(OH)₂ used to produce the NaOH. In addition, NaOH can optionally be re-introduced to the process upstream of the PLS purification process in step 304 to reduce reagent cost.

The solution resulting from step 500 may contain residual lithium. At step 502, the residual lithium may be used to produce lithium materials that are additional to the Li₂CO₃ produced in step 308. In one embodiment of step 502, CO₂ gas is reacted with lithium in the solution resulting from step 500 in accordance with Eqn. 5, to yield Li₂CO₃.

$$2 {LiOH}_{( aq )} + {CO}_{2 ( g )} \to {Li}_{2} C {O}_{3 ( s )} ↓ + {H}_{2} {O}_{( a q )} \qquad ( Eqn . 5 )$$

In embodiments as illustrated at step 502 of FIG. 5, phosphoric acid (H₃PO₄) may be added to the solution resulting from step 500 to yield Li₃PO₄. This reaction is analogous to the reactions described above in step 312 of the method of FIG. 3 and in step 416 of the method of FIG. 4. As such, it will be understood that such description applies in the context of step 502 of FIG. 5.

The CO₂ used in step 502 may be obtained from a variety of sources. In one embodiment, the CO₂ may be separated from a flue gas of an industrial process, which may be of the same lithium plant. In another embodiment, the flue gas may result from the combustion of fossil fuels to produce heat for calcination of the α-spodumene concentrate in step 300 of the method, and/or for acid roasting of the β-spodumene in step 302 of the method, and/or for steam generation by a boiler in a utilities area of the plant. The generated steam may be used throughout the process, as known in the prior art. If so, then CO₂ emissions from the lithium plant can be reduced. In a further embodiment, the CO₂ may be obtained from open air, which will reduce the CO₂ number in a global way. Suitable equipment and processes are known in the prior art for separation of CO₂ gas from flue gas. Non-limiting examples include physical or chemical absorption-based methods (e.g., using monoethanolamine (MEA) solvent, caustic, ammonia solution), physical or chemical adsorption-based methods (e.g. using molecular sieves. activated carbon, metallic oxides), cryogenic methods, and membrane-based methods that rely on gas separation, or gas absorption phenomena, as known in the prior art. Non-CO₂ components of the flue gas may optionally be treated before being emitted to the atmosphere, sequestered, or otherwise treated in some manner.

Further, it will be understood that a portion or all of the Li₂CO₃ produced by step 502 may be separated and sold to market as a product.

In embodiments as illustrated in FIG. 5, step 502 is shown as being performed after step 500. In other embodiments, step 502 may be performed directly on the mother liquor resulting from step 306, and before performing step 500. This alternative embodiment is within the scope of the present invention.

### Example No. 4: Production of LiOH—H₂O Primary Lithium Product, and CaSO₄ and NaOH Byproducts by Reaction of Na₂SO₄ with an Alkali Chemical

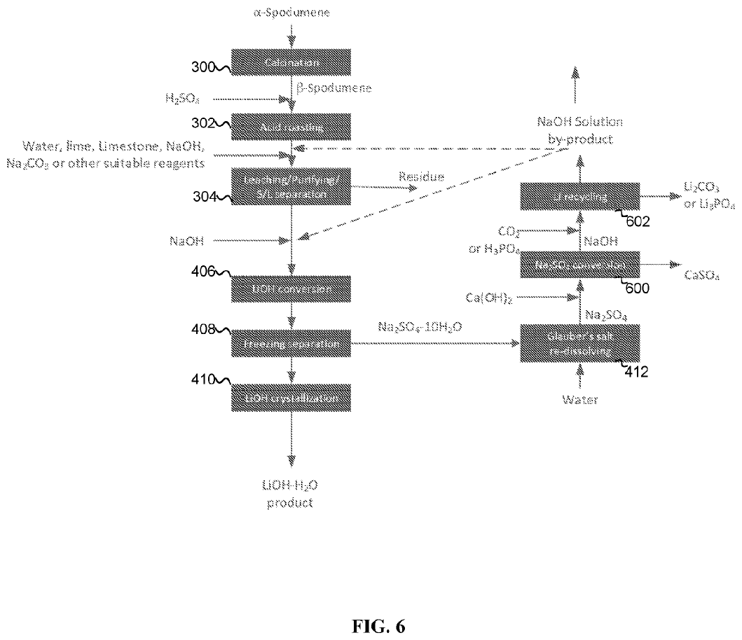

FIG. 6 represents a flow chart for an embodiment of a method of the present invention for processing α-spodumene concentrate to produce LiOH—H₂O, and converting a Na₂SO₄ intermediate product to a byproduct of solid CaSO₄ and a solution of NaOH, using an alkali chemical of Ca(OH)₂. As noted above in respect to the method of FIG. 5, other alkali chemicals (e.g., NH₄OH, Ba(OH)₂, KOH) or mixtures of them, may be used instead to produce different byproducts as summarized in Table 2.

In embodiments, as illustrated in FIG. 6, steps 300, 302, 304, are analogous to the same numbered steps of the method illustrated in FIG. 3, and steps 406, 408, 410, and 412 are analogous to same numbered steps of the method illustrated in FIG. 4. As such, it will be understood that description of those steps may apply to the respective analogous step in the method illustrated in FIG. 6.

At step 412 of FIG. 6, the Glauber's salt that is produced from the freezing separation process of step 408 may be re-dissolved in water to produce a solution of Na₂SO₄.

At step 600 of FIG. 6, the solution of Na₂SO₄ resulting from step 412 may be mixed with Ca(OH)₂ so that the dissolved Na₂SO₄ and the Ca(OH)₂ react to convert the Na₂SO₄ to CaSO₄ and NaOH. This reaction is analogous to the reaction described above in step 500 of the method illustrated in FIG. 5. As such, it will be understood that such description may apply in the context of step 600 of FIG. 6. A portion or all of the NaOH may be sold to market as a product. In addition or in alternative, a portion or all of the NaOH may optionally be re-introduced to the process for use in the PLS purification process of step 304. In addition or in alternative, a portion or all of the NaOH may optionally be re-introduced to the process for use in the LiOH conversion process of step 406.

The solution resulting from step 600 may contain residual lithium. This residual lithium may be used to produce lithium materials that are additional to the LiOH produced in step 410. In embodiments as illustrated in FIG. 6 at step 602, CO₂ gas may react with lithium in the solution resulting from step 600 to yield Li₂CO₃. In embodiments as illustrated in FIG. 6 at step 602, phosphoric acid (H₃PO₄) may be added to the solution resulting from step 600 to yield Li₃PO₄. These reactions are analogous to the reactions described above in step 502 of the method illustrated in FIG. 5. As such, it will be understood that such description applies in the context of step 602 of FIG. 6. In embodiments as illustrated in FIG. 6, step 602 is shown as being performed after step 600. In alternative embodiments, step 602 may be performed directly on the solution resulting from step 412, before performing step 600. This alternative embodiment is within the scope of the present invention.

### Example No. 5: Production of Li₂CO₃ Primary Lithium Product, and NaOH and H₂SO₄ Byproducts by Electrolysis or Electrodialysis of Na₂SO₄

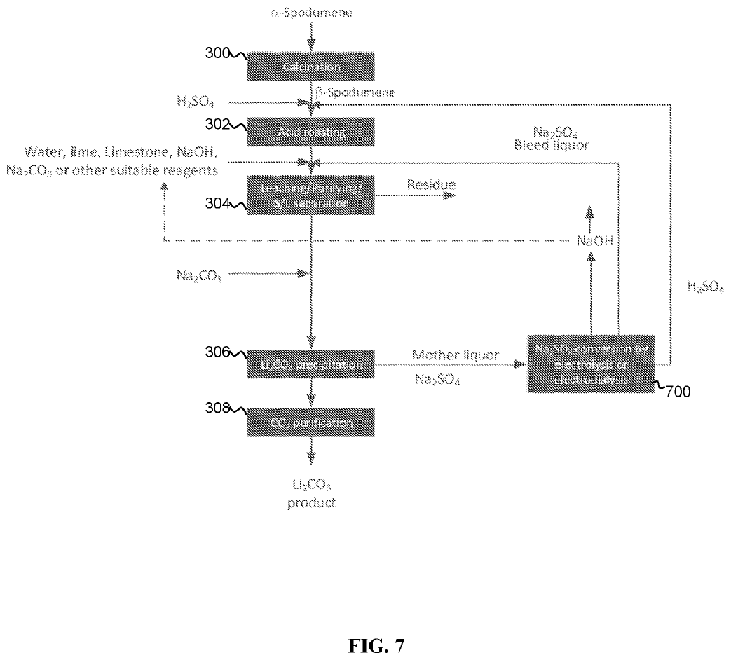

FIG. 7 represents a flow chart of an embodiment of a method of the present invention for processing α-spodumene concentrate to produce a Li₂CO₃ primary lithium product, and NaOH and H₂SO₄ byproducts. In this example, the NaOH and H₂SO₄ byproducts are produced by electrolysis or electrodialysis of a Na₂SO₄ intermediate product, which is being used as the electrolyte.

In embodiments as illustrated in FIG. 7, steps 300, 302, 304, 306, 308, are analogous to same numbered steps of the method of FIG. 3. As such, it will be understood that description of those steps may also apply to the respective analogous step in the method of FIG. 7.

The mother liquor that was separated from the precipitated Li₂CO₃ at step 306 comprises Na₂SO₄. As illustrated in FIG. 7, at step 700, the mother liquor may be subjected to either electrolysis, or electrodialysis, or both of them, so that the Na₂SO₄, used as the electrolyte, may be converted to separate streams of NaOH solution and H₂SO₄ solution, as follows.

The NaOH and H₂SO₄ streams may be separated automatically as a result of electrolysis or electrodialysis, without need for further separating processing.

$${Na}_{2} {SO}_{4} + 2 {H}_{2} O {⟶}^{Electrolysis} 2 NaOH + {H}_{2} {SO}_{4} \qquad ( Eqn . 6 a )$$

$${Na}_{2} {SO}_{4} + 2 {H}_{2} O {⟶}^{Electrodialysis} 2 NaOH + {H}_{2} {SO}_{4} \qquad ( Eqn . 6 b )$$

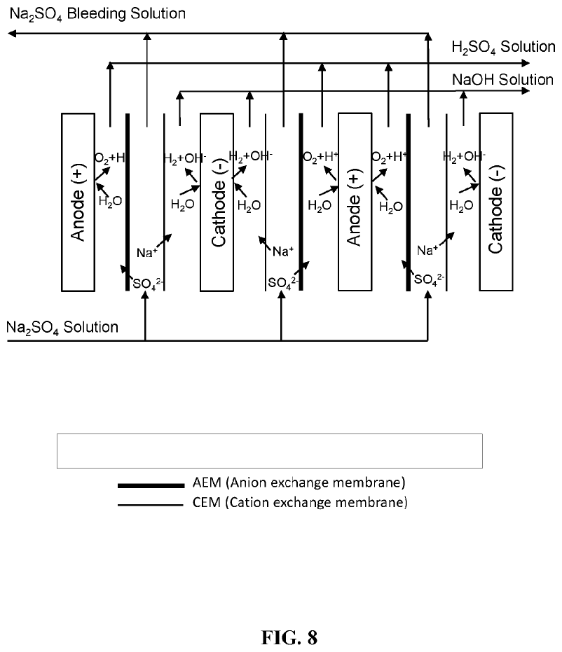

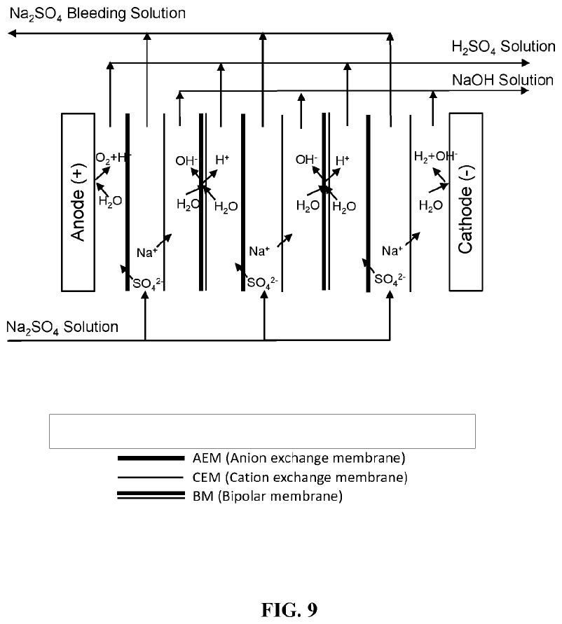

The principles of electrolysis or electrodialysis are well understood to the person of ordinary skill in the art, and as such, they are not described in detail herein. For completeness, FIG. 8 represents a schematic diagram illustrating Na₂SO₄ conversion to NaOH and H₂SO₄ with an embodiment of an electrolysis process. FIG. 9 represents a schematic diagram illustrating Na₂SO₄ conversion to NaOH and H₂SO₄ with an embodiment of a bipolar membrane electrodialysis (BMED) method. Electrolysis or electrodialysis have their respective advantages, but both may be used to realize the Na₂SO₄ conversion as desired.

The difference between electrolysis and electrodialysis is as follows. Electrolysis uses one or more electrolysis cells with each cell having a positive electrode and a negative electrode. In contrast, electrodialysis uses one or more electrodialysis chambers combined together, but having only one positive electrode and negative electrode at two ends of the combined stack.

In comparison with the prior art process shown in FIG. 1, step 700 as illustrated in FIG. 7 may be advantageous at least in the following respects. First, a crystallization circuit for treating the Na₂SO₄ may be avoided or at least be reduced in capacity, to reduce its associated capital and operating cost.

Second, NaOH and H₂SO₄ typically have higher value and better marketability potential than the Na₂SO₄. As such, a portion or all of the NaOH stream and H₂SO₄ stream may be sold directly on market.

Third, in addition or in the alternative, a portion or all of the NaOH stream may be re-used in the process to reduce the reagent cost of the method herein disclosed. Further, by doing so, any lithium that is contained in the NaOH stream may be kept in the process, which may improve the total lithium recovery in the method disclosed herein, in comparison to the conventional process of FIG. 1.

A portion or all of the NaOH stream resulting from step 700 may be re-used to the PLS purification process of step 304 of the method disclosed herein.

Fourth, a portion or all of the H₂SO₄ stream resulting from step 700 may be re-used in the acid roasting process of step 302 to reduce the reagent cost of the method. Further, by doing so, any lithium that is contained in the H₂SO₄ stream may be kept in the process, which may improve the total lithium recovery in the method, in comparison to the conventional process of FIG. 1.

Step 700 as illustrated in FIG. 7 may also result in the production of a bleed liquor—i.e., the Na₂SO₄ electrolyte stream that is not converted to H₂SO₄ or NaOH and flows out from the electrolytic cell or electrolytic chamber, and has a lower Na₂SO₄ concentration than the electrolyte stream that flows into the electrolytic cell or electrolytic chamber. The bleed liquor may be directed to upstream of the leaching process of step 304 to make slurry from the acid-roasted spodumene.

### Example No. 6: Production of LiOH—H₂O Primary Lithium Product, and NaOH and H₂SO₄ Byproducts by Electrolysis or Electrodialysis of Na₂SO₄

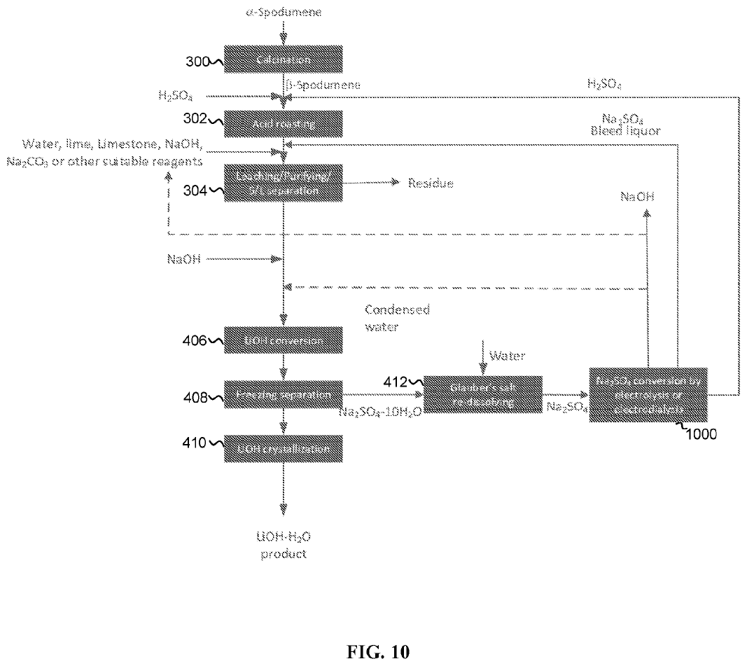

FIG. 10 represents a flow chart for an embodiment of a method of the present invention for processing α-spodumene concentrate to produce a LiOH—H₂O primary lithium product, NaOH and H₂SO₄ byproducts. In this example, the NaOH and H₂SO₄ byproducts may be produced by electrolysis or electrodialysis of a Na₂SO₄ intermediate product, being used as the electrolyte, as illustrated in FIGS. 8, 9 and 10.

In embodiments, steps 300, 302, and 304 of the method illustrated in FIG. 10 are analogous to same numbered steps of the method illustrated in FIG. 3, and steps 406, 408, 410 and 412, are analogous to same numbered steps of the method of FIG. 4. As such, it will be understood that description of those steps may also apply to the respective analogous steps in the method illustrated in FIG. 10.

At step 412 of FIG. 10, the Glauber's salt that is produced from the freezing separation process of step 408 may be re-dissolved in water to produce a solution of Na₂SO₄. At step 1000, the solution of Na₂SO₄ resulting from step 412 may be subjected to either electrolysis, or electrodialysis, or both of them, so that the dissolved Na₂SO₄, used as the electrolyte, may be converted to separate streams of NaOH solution and H₂SO₄ solution. This reaction is analogous to the reaction described above in step 700 of the method illustrated in FIG. 7. As such, it will be understood that such description applies in the context of step 1000 of FIG. 10, with the necessary adaptations.

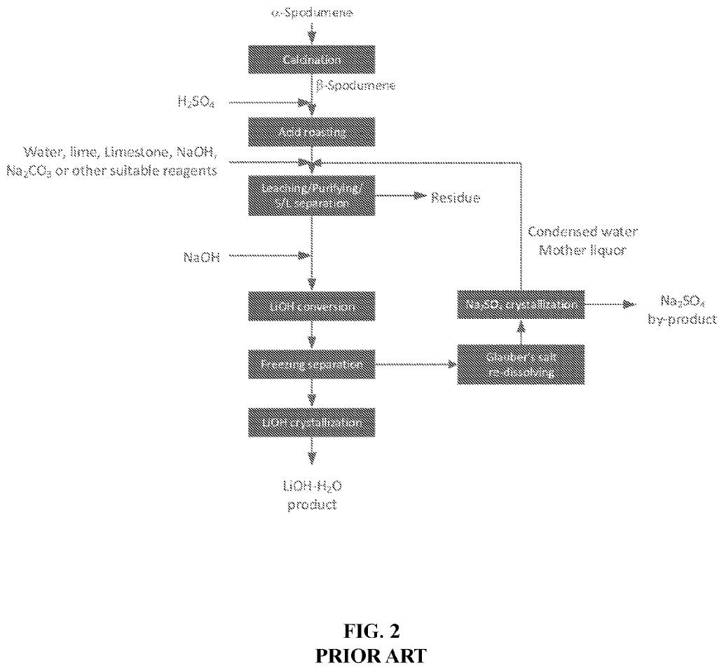

A portion or all of the NaOH stream and H₂SO₄ stream may be sold directly on market. In addition or in the alternative, a portion or all of the NaOH stream may be re-used in the process to reduce the reagent cost of the method. Further, by doing so, any residual lithium that is contained in the NaOH stream will thereby be kept in the process, which may improve the total lithium recovery in the method, as compared with the conventional process of FIG. 2.

A portion or all of the NaOH stream resulting from step 1000 may be re-used in the process in one or all of the following ways. A portion or all of the NaOH stream may be re-used in the PLS purification process of step 304 of the method. In addition or in the alternative, a portion or all of the NaOH stream may optionally be re-used in the LiOH conversion process of step 406 of the method illustrated in FIG. 10.

A portion or all of the H₂SO₄ stream resulting from step 1000 may be re-used in the acid roasting process of step 302 to reduce the reagent cost of the method. Further, by doing so, any lithium that is contained in the H₂SO₄ stream may be kept in the process, which may improve the total lithium recovery in the method, as compared with the conventional process of FIG. 2, known in the prior art.

Step 1000 may also result in the production of a bleed liquor—i.e., the Na₂SO₄ electrolyte stream that is not converted to H₂SO₄ or NaOH and flows out from the electrolytic cell or electrolytic chamber, and has a lower Na₂SO₄ concentration than the electrolyte stream that flows into the electrolytic cell or electrolytic chamber. The bleed liquor may be directed to upstream of the leaching process of step 304 to make slurry from the acid-roasted spodumene.

### Definitions

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

“Alkali chemical”, as used herein, refers to a chemical selected from the group consisting of calcium hydroxide (Ca(OH)₂), ammonium hydroxide (NH₄OH), barium hydroxide (Ba(OH)₂), potassium hydroxide (KOH), and mixtures of any of the foregoing.

“Flue gas”, as used herein, refers to a gas comprising CO₂ gas produced as an emission from the combustion of a fossil fuel. As non-limiting examples, flue gas may be CO₂ gas mixed with non-CO₂ gases such as water vapor, oxygen, carbon monoxide, nitrogen oxides, and sulfur oxide.

“Salt chemical”, as used herein, refers to a chemical selected from the group consisting of barium chloride (BaCl), calcium chloride (CaCl₂)), calcium nitrate (Ca(NO₃)₂), copper nitrate (Cu(NO₃)₂), nickel chloride (NiCl₂), nickel nitrate (Ni(NO₃)₂), potassium carbonate (K₂CO₃), and any mixtures of the foregoing.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

The corresponding structures, materials, acts, and equivalents of all means or steps plus function elements in the claims appended to this specification are intended to include any structure, material, or act for performing the function in combination with other claimed elements as specifically claimed.

As used herein, the term “comprising” is intended to mean that the list of elements following the word “comprising” are required or mandatory but that other elements are optional and may or may not be present. As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein, the term “consisting of” is intended to mean including and limited to whatever follows the phrase “consisting of”. Thus, the phrase “consisting of” indicates that the listed elements are required or mandatory and that no other elements may be present.

It is noted that terms like “preferably”, “commonly”, “generally”, and “typically” are not utilized herein to limit the scope of the claimed invention or to imply that certain features are critical, essential, or even important to the structure or function of the claimed invention. Rather, these terms are merely intended to highlight alternative or additional features that can or cannot be utilized in a particular embodiment of the present invention.

For the purposes of describing and defining the present invention it is noted that the term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

1. A method of processing an aqueous feed solution comprising lithium sulfate to produce a primary lithium product and a byproduct, the method comprising the steps of:
(a) reacting the aqueous feed solution with a primary reagent to produce a mixed solution comprising the primary lithium product and sodium sulfate, wherein either:
(i) the primary reagent comprises sodium carbonate and the primary lithium product comprises lithium carbonate; or
(ii) the primary reagent comprises sodium hydroxide and the primary lithium product comprises lithium hydroxide;
(b) separating the primary lithium product from the mixed solution, and producing a separated sodium sulfate solution from the mixed solution, wherein:
(i) if the primary lithium product comprises lithium carbonate, then:
(A) separating the primary lithium product from the mixed solution comprises crystallizing the lithium carbonate from the mixed solution; and
(B) the separated sodium sulfate solution comprises a solution remaining after step (b)(i)(A); or
(ii) if the primary lithium product comprises lithium hydroxide, then:
(A) producing the separated sodium sulfate solution from the mixed solution comprises separating decahydrate of sodium sulfate from the mixed solution, and dissolving the separated decahydrate of sodium sulfate in water; and
(B) separating the primary lithium product from the mixed solution comprises crystallizing the lithium hydroxide from a solution remaining after step (b)(ii)(A); and
(c) performing a conversion process on the separated sodium sulfate solution to produce to produce sodium hydroxide and sulfuric acid, the conversion process comprising removing multivalent ion impurities from the separated sodium sulfate solution and:
(i) providing the separated sodium sulfate solution to a three-compartment electrolysis cell comprising at least an anion exchange membrane and a cation exchange membrane and configured to operate below 70° C.; or
(ii) providing the separated sodium sulfate solution to a three-compartment electrodialysis cell comprising at least an anion exchange membrane, a cation exchange membrane and a bi-polar membrane and configured to operate below 50° C.; and
(d) recovering an output stream comprising the sodium hydroxide and an output stream comprising the sulfuric acid, wherein the output streams are substantially free of sodium sulfate.

2. The method of claim 1, further comprising, before step (a), preparing the aqueous feed solution by reacting a lithium-containing material with sulfuric acid.

3. The method of claim 2, wherein the lithium-containing material comprises a mineral.

4. The method of claim 3, wherein before step (a), the method comprises a step of subjecting the mineral to a calcination process for phase conversion of the mineral.

5. The method of claim 3, wherein the mineral comprises spodumene.

6. The method of claim 3 wherein the mineral comprises petalite, lepidolite, zinnwaldite, amblygonite, eucryptite, hectorite, a lithium clay, or jadarite.

7. The method of claim 2, wherein the lithium-containing material comprises lithium carbonate.

8. The method of claim 2, wherein the lithium-containing material comprises material from a used battery.

9. The method of claim 1, wherein the primary reagent comprises sodium carbonate and the primary lithium product comprises lithium carbonate.

10. The method of claim 1, wherein the primary reagent comprises sodium hydroxide and the primary lithium product comprises lithium hydroxide.

11. A method of processing an aqueous feed solution comprising lithium sulfate to produce a primary lithium product and a byproduct, the method comprising the steps of:
(a) reacting the aqueous feed solution with a primary reagent to produce a mixed solution comprising the primary lithium product and sodium sulfate, wherein either:
(i) the primary reagent comprises sodium carbonate and the primary lithium product comprises lithium carbonate; or
(ii) the primary reagent comprises sodium hydroxide and the primary lithium product comprises lithium hydroxide;
(b) separating the primary lithium product from the mixed solution, and producing a separated sodium sulfate solution from the mixed solution, wherein:
(i) if the primary lithium product comprises lithium carbonate, then:
(A) separating the primary lithium product from the mixed solution comprises crystallizing the lithium carbonate from the mixed solution; and
(B) the separated sodium sulfate solution comprises a solution remaining after step (b)(i)(A); or
(ii) if the primary lithium product comprises lithium hydroxide, then:
(A) producing the separated sodium sulfate solution from the mixed solution comprises separating decahydrate of sodium sulfate from the mixed solution, and dissolving the separated decahydrate of sodium sulfate in water; and
(B) separating the primary lithium product from the mixed solution comprises crystallizing the lithium hydroxide from a solution remaining after step (b)(ii)(A); and
(c) performing a conversion process on the separated sodium sulfate solution to produce the byproduct, the conversion process comprising:
reacting the separated sodium sulfate solution with a salt chemical, wherein: the salt chemical comprises calcium nitrate, and the byproduct comprises calcium sulfate and sodium nitrate; the salt chemical comprises barium chloride and the byproduct comprises barium sulfate and sodium chloride; the salt chemical comprises calcium chloride and the byproduct comprises calcium sulfate and sodium chloride; the salt chemical comprises copper nitrate and the byproduct comprises copper sulfate and sodium nitrate; the salt chemical comprises nickel chloride and the byproduct comprises nickel sulfate and sodium chloride; the salt chemical comprises nickel nitrate and the byproduct comprises nickel sulfate and sodium nitrate; or the salt chemical comprises potassium carbonate, and the byproduct comprises potassium sulfate and sodium carbonate; and
(d) recovering residual lithium, wherein a solution resulting from step (c) comprises lithium ions, the recovering comprising providing, to the solution resulting from step (c), a secondary reagent comprising phosphoric acid, thereby reacting the lithium ions to produce a secondary lithium product comprising lithium phosphate.

12. The method of claim 11, further comprising, before step (a), preparing the aqueous feed solution by reacting a lithium-containing material with sulfuric acid.

13. The method of claim 12, wherein the lithium-containing material comprises spodumene.

14. The method of claim 12, wherein the lithium-containing material comprises petalite, lepidolite, zinnwaldite, amblygonite, eucryptite, hectorite, a lithium clay, or jadarite.

15. The method of claim 12, wherein the lithium-containing material comprises material from a used battery.

16. A method of processing an aqueous feed solution comprising lithium sulfate to produce a primary lithium product and a byproduct, the method comprising the steps of:
(a) reacting the aqueous feed solution with a primary reagent to produce a mixed solution comprising the primary lithium product and sodium sulfate, wherein either:
(i) the primary reagent comprises sodium carbonate and the primary lithium product comprises lithium carbonate; or
(ii) the primary reagent comprises sodium hydroxide and the primary lithium product comprises lithium hydroxide;
(b) separating the primary lithium product from the mixed solution, and producing a separated sodium sulfate solution from the mixed solution, wherein:
(i) if the primary lithium product comprises lithium carbonate, then:
(A) separating the primary lithium product from the mixed solution comprises crystallizing the lithium carbonate from the mixed solution; and
(B) the separated sodium sulfate solution comprises a solution remaining after step (b)(i)(A); or
(ii) if the primary lithium product comprises lithium hydroxide, then:
(A) producing the separated sodium sulfate solution from the mixed solution comprises separating decahydrate of sodium sulfate from the mixed solution, and dissolving the separated decahydrate of sodium sulfate in water; and
(B) separating the primary lithium product from the mixed solution comprises crystallizing the lithium hydroxide from a solution remaining after step (b)(ii)(A); and
(c) performing a conversion process on the separated sodium sulfate solution to produce the byproduct, the conversion process comprising reacting the separated sodium sulfate solution with an alkali chemical, wherein: the alkali chemical comprises calcium hydroxide, and the byproduct comprises calcium sulfate and sodium hydroxide; the alkali chemical comprises ammonium hydroxide, and the byproduct comprises ammonium sulfate and sodium hydroxide; the alkali chemical comprises barium hydroxide, and the byproduct comprises barium sulfate and sodium hydroxide; or the alkali chemical comprises potassium hydroxide, and the byproduct comprises potassium sulfate and sodium hydroxide; and
(d) recovering residual lithium, wherein a solution resulting from step (c) comprises lithium ions, the recovering comprising providing, to the solution resulting from step (c), a secondary reagent comprising phosphoric acid, thereby reacting the lithium ions to produce a secondary lithium product comprising lithium phosphate.

17. The method of claim 16, further comprising, before step (a), preparing the aqueous feed solution by reacting a lithium-containing material with sulfuric acid.

18. The method of claim 17, wherein the lithium-containing material comprises spodumene.

19. The method of claim 17, wherein the lithium-containing material comprises petalite, lepidolite, zinnwaldite, amblygonite, eucryptite, hectorite, a lithium clay, or jadarite.

20. The method of claim 17, wherein the lithium-containing material comprises material from a used battery.

21-53. (canceled)
